(19) United States
(12) Patent Application Publication
(10) Pub. No.: US 2008/0229669 A1
(43) Pub. Date: Sep. 25, 2008

(54) FLIP TOP ADJUSTABLE THRESHOLD CAP

(75) Inventors: Joshua Abdollahzadeh, High Point, NC (US); Sean Gilboy, Reidsville, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Endura Products, Inc., Colfax, NC (US)

(21) Appl. No.: 11/688,288

(22) Filed: Mar. 20, 2007

(51) Int. Cl. E06B 1/70

(52) U.S. Cl. 49/468

(57) ABSTRACT

A vertically adjustable threshold cap is provided for installation in a door sill assembly. The threshold cap includes a lower portion that facilitates vertical adjustment, having pedestals that can be manipulated to achieve vertical adjustment. A cover is connected to the lower portion, and has an access position whereby a user can access and adjust the pedestals, and a closed position whereby no access is provided. The cover may be integrally connected to the lower portion.

### FIELD OF THE INVENTION

The present invention relates generally to entry door sill constructions, and more particularly, to a door sill assembly having an adjustable threshold.

### BACKGROUND OF THE INVENTION

Residential entry doors conventionally have been constructed with door threshold sill assemblies that are designed to seal against the weather, particularly wind and water, when the door is closed. A wide variety of door sill assemblies include adjustable threshold caps, these caps being the portion of the threshold that provides sealing contact with the bottom of the door or the door sweep. These adjustable threshold assemblies assist in creating an effective weather seal at the threshold.

Adjustable caps allow an installer, or a subsequent homeowner/resident, to optimize the fit of a specific door as necessary. By adjusting the vertical clearance properly, wind and water are more effectively excluded without hampering the opening and closing of the door.

In addition to the practical and functional sealing characteristics of a threshold sill assembly, it is desirable that the assembly be inexpensively manufactured, and aesthetically pleasing. While most threshold assemblies are constructed of wood, or have a wood grain appearance, the adjustment screws for these adjustable thresholds are usually visible when the door is opened. Not only does this detract from the appearance of the threshold and sill, but the recessed screws can also diminish the weather seal along the surface of the threshold cap. Similarly, color conforming caps or cap plugs that have been used to cover the screws tend to project upwardly, also reducing the effectiveness of the seal in the areas of the caps. Also, these caps or cap plugs can be damaged, loosened, and/or lost.

Thus, there is a need for an adjustable threshold cap having a smooth upper surface, that is easily adjusted, and yet is aesthetically pleasing.

### SUMMARY OF THE INVENTION

One aspect of the present invention is directed to a vertically adjustable threshold cap capable of installation in a door sill assembly. The threshold cap includes a lower portion and a cover. The lower portion facilitates the vertical adjustment of the threshold cap and can include pedestals that can be manipulated to achieve vertical adjustment. The cover is connected to the lower portion, and has both an access position whereby a user can access and adjust the pedestals, and a closed position whereby no access is provided.

Another aspect of the present invention is directed to a threshold sill assembly for installation beneath entryways having a hinged door panel that, when closed, overlies the door sill assembly. The assembly includes an elongated base that can define, in one embodiment, an upwardly open channel along an inside edge portion, the channel having an inside wall, an outside wall, and a bottom. A threshold cap is positioned in the upwardly open channel for underlying a closed door, and is vertically adjustable within the channel to provide a tight fit between the threshold cap and the bottom of the hinged door panel when the door panel is closed. The threshold cap can include the lower portion and cover described above.

A further aspect of the present invention is directed to a method for vertically adjusting a threshold cap installed in a door sill assembly, where the threshold cap has a lower portion with pedestals for vertical adjustability, and a cover connected to the lower portion. The method includes moving the cover to an access position, adjusting the pedestals to a desired height, and moving the cover to a closed position, whereby no access is provided.

### BRIEF DESCRIPTION OF THE DRAWINGS

FIG. 1 is a front perspective view of the threshold sill assembly of the present invention with a vertically adjustable threshold cap.

FIG. 2 is a rear perspective view of the threshold sill assembly of FIG. 1.

FIG. 3 is a rear perspective view of the threshold sill assembly of FIG. 1 with the top cover of the adjustable threshold cap in an open position.

FIG. 4A is an end elevational view of the threshold sill assembly, illustrating the threshold cap in its lowest vertical position within the channel.

FIG. 4B is an end elevational view of the threshold sill assembly, illustrating the threshold cap in a vertically raised position within the channel.

### DESCRIPTION OF THE PREFERRED EMBODIMENT

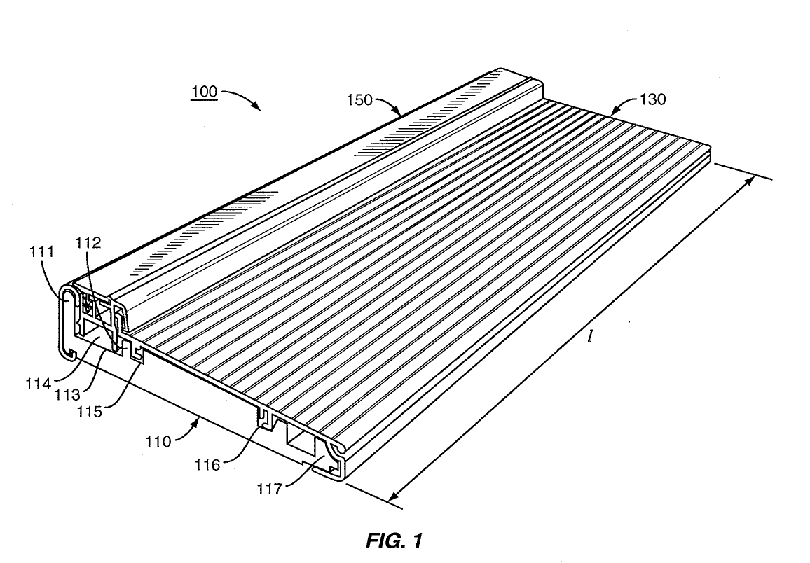

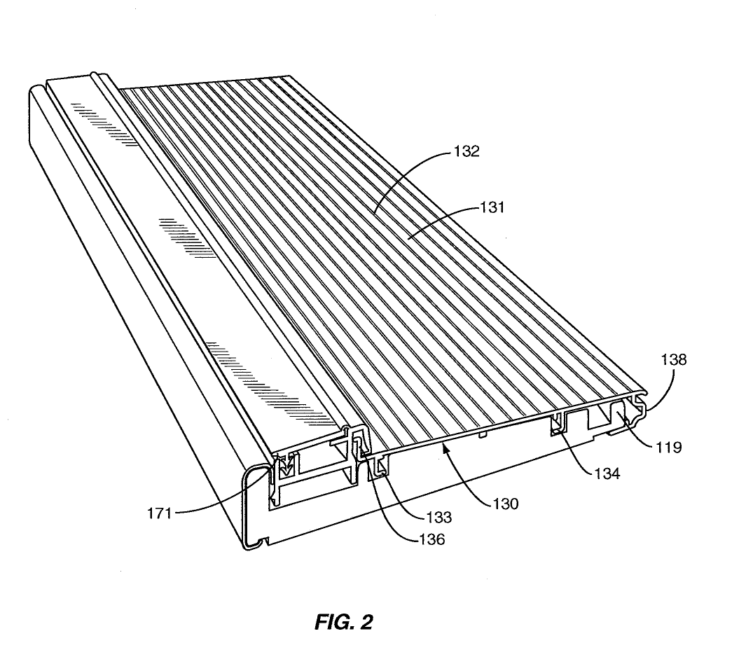

Referring to the Figures in general, one aspect of the present invention is directed to a vertically adjustable threshold cap adapted for installation in a door sill assembly, and to a threshold sill assembly incorporating an adjustable threshold cap. Shown generally as 100 in FIGS. 1 and 2, in its simplest form the threshold sill assembly 100 comprises an elongated base 110, a sill plate 130, and a threshold cap 150.

As shown in FIG. 1, the threshold and door assembly has a longitudinal length, l. The actual length, l, of the assembly 100 will, of course, correspond to the approximate dimension of the entry door panel beneath which threshold sill assembly 100 is to be installed.

The elongated base 110 can comprise a rigid, extruded plastic block that provides both a support substrate for the sill plate 130 and can be shaped to define an upwardly open channel 114 proximate the rear end of the base 110. The open channel 114 further can comprise a substantially vertical inner wall 111, a substantially vertical outer wall 112, and a relatively flat bottom 113 spanning the distance between the inner and outer walls 111, 112. Longitudinal slots 115, 116 can be formed along at least some portion of the length, l, of the base 110 for engagement with the sill plate 130, as described below. While the channel 114 is shown in FIG. 1 residing within a single component base 110, the channel also can be formed as a result of a base and nosing and other components, that combine to form a channel 114.

In one embodiment, the sill plate 130 is formed of a singular piece of extruded aluminum. The sill plate 130 is mounted atop the elongated base 110, which can incline downwardly to a front edge 117. The sill plate 130 comprises a deck 131 that is also downwardly sloping and may conform to the contour, shape, and slope of the base 110. As will be appreciated, the deck 131 further can comprise a series of optional spaced-apart ridges 132 that are provided for gripping contact with a user's foot or footwear when the user steps onto the deck 131 when entering or departing through the doorway. Projecting downwardly from the bottom surface of the deck 131 can be longitudinally extending ribs 133 and 134. These ribs 133, 134 can be spaced and dimensioned for insertion into the longitudinal slots 115 and 116 formed in the elongated base 110. When inserted, the ribs 133, 134 can help to secure the sill plate 130 and deck 131 atop the base 110 so that the deck 131 cannot slide out of its desired position once installed. While the ribs 133, 134 are shown as having an L-shaped geometry, the geometry is not a limitation to the present invention so long as the plate 130 is secured to the base 110. Further, the outside edge 138 of the sill plate 130 can be configured to profile, or fit over and around the forward edge 119 of the base 110. The edge 138 can serve to both protect the underlying substrate 110 and to conceal the substrate in order to provide a more aesthetic appearance.

Extending upwardly from the inner edge of the deck 131 can be a vertical wall 136, which also extends longitudinally the length of the base 110. So formed, this vertical wall 136 can define a dam to prevent the intrusion of water or other elements into and through the channel 114 or threshold cap 150. As explained below, the vertical wall 136 can cooperate with a flexible sealing flange 169 on the threshold cap 150.

The threshold cap 150 is disposed in the channel 114 that is formed in the base 110. In one embodiment, the threshold cap 150 is formed as a singular body from an extruded, durable plastic. The particular placement of the threshold cap 150 is selected so that it substantially underlies the door panel (not shown) when the door is in the closed position. When the door is opened, the threshold cap 150 presents a smooth and continuous surface, with no visible screws, caps, etc. With the door open, the threshold cap 150 is accessible for in situ vertical adjustment within the channel 114. The threshold cap 150 may also be removable to facilitate vertical adjustment remotely from the door, or to permit replacement of the threshold cap 150 due to wear and tear.

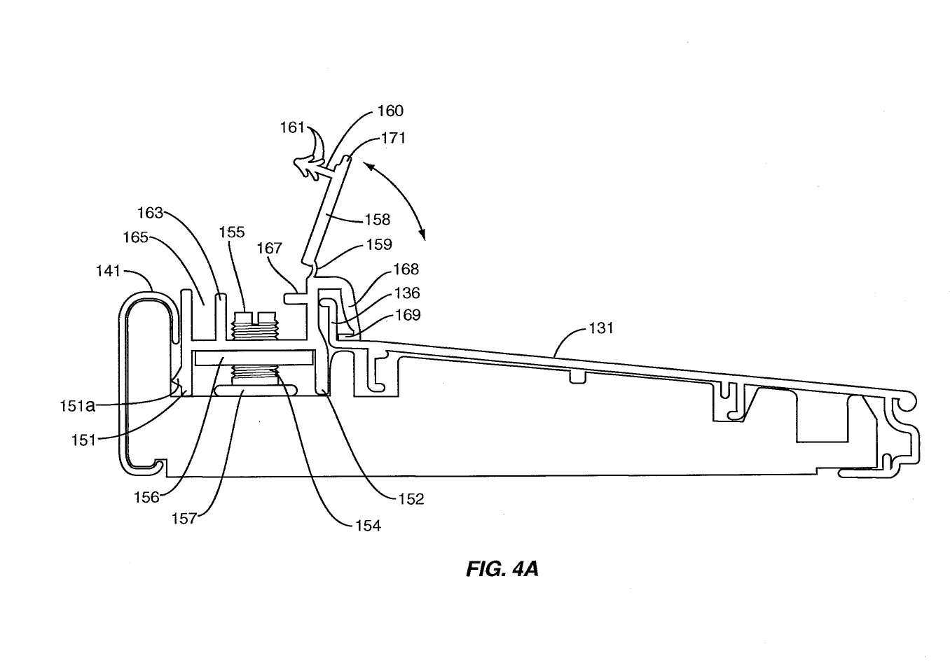

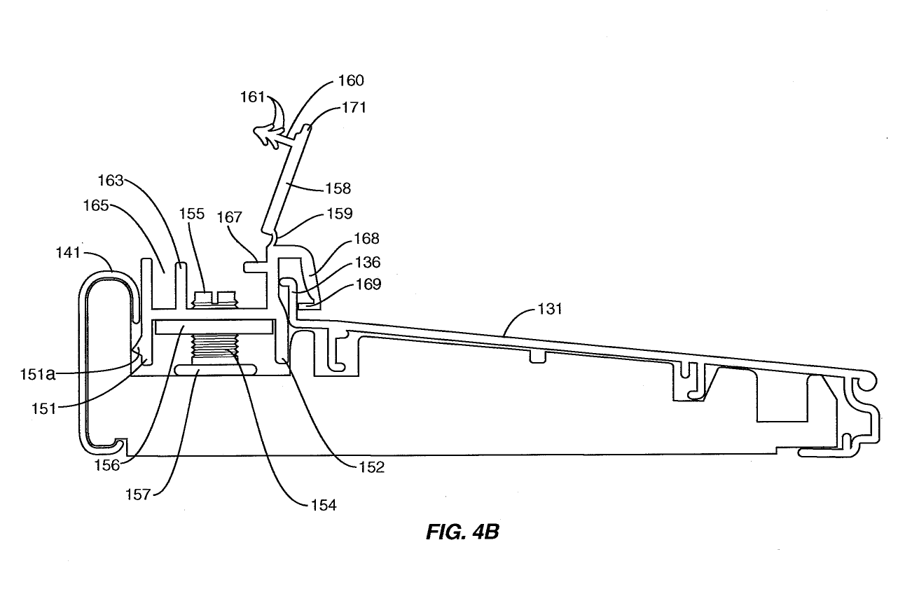

FIGS. 4A and 4B are exemplary of the vertical adjustability of the threshold cap 150 within the channel 114. FIG. 4A illustrates the threshold cap at its lowest position within the channel 114 and FIG. 4B illustrates the threshold cap in a vertically elevated position relative to the channel 114.

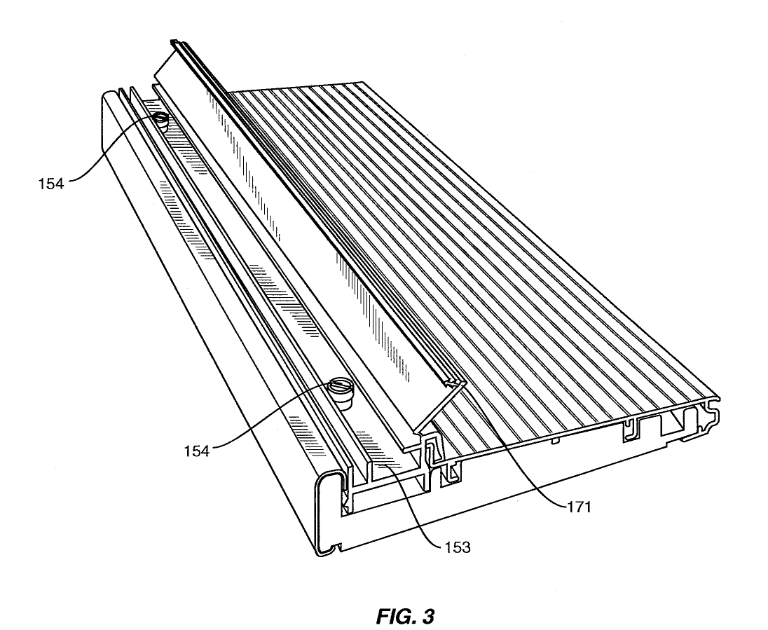

The threshold cap 150 can comprise spaced apart, downwardly extending inner 151 and outer 152 legs. Extending between and connecting the inner and outer legs 151, 152, can be one or more webs 153 (FIG. 3) that are substantially horizontal and formed a selected distance above the bottom of the lower edges of the legs 151, 152. In one embodiment, the web 153 is a singular member that extends longitudinally along the length, l, of the assembly 100 (as shown in FIG. 3); however, as will be appreciated, the web 153 may comprise not only a continuous member, but also a plurality of smaller horizontal elements (not shown) that are spaced apart along the length of the threshold cap 150.

As shown in FIG. 3, at least two spaced apart threaded pedestals 154 extend through apertures (not shown) in the web 153 for adjusting the height of the threshold cap 150 relative to the bottom 113 of the channel 114. When the web comprises a plurality of spaced apart elements that interconnect the inner and outer walls 151, 152, the web elements can be formed at positions where the threaded pedestals 154 are to be located.

The number and distance between threaded pedestals 154 may vary depending upon the length and anticipated service requirements of the assembly 100. The top 155 of each threaded pedestal 154 is configured for turning engagement by a conventional screwdriver or other suitable tool. In the embodiment shown in the Figures, the top 155 is slotted for a standard flat-tip screwdriver. To adjust the height of the threshold cap 150, an installer or user can turn the threaded pedestal 154 either clockwise or counterclockwise (when viewed from the top) to either raise or lower, respectively, the threshold cap 150. When the threaded pedestal 154 is adjusted, the pedestal's threads can engage a threaded lug 156, or nut, directly beneath the web 153. This mechanical rotation of the pedestal 154 within the lug 156 either extends the pedestal 154 further into the channel 114 or withdraws it from the channel. To provide for additional stability and enhanced load bearing ability, a foot 157 can be affixed at the bottom of each pedestal 154 for solid engagement with the bottom 113 of the channel 114. As shown in FIG. 4A, the threshold cap 150 is at its lowest vertical position when the bottom edges of the inner 151 and outer 152 legs are resting on the bottom 113 of the channel 113. Again, as shown in FIG. 4B, the threshold cap 150 is shown in a vertically elevated position within the channel 114. In this position, the threaded pedestals 154 are bearing substantially all of the load for the threshold cap 150. Further, as shown in FIGS. 4A and 4B, the inner 151 and outer 152 legs can provide sliding engagement and stability for the inner and outer walls 111, 112 within the channel 114. Additionally, a projection 151a can be formed on the inner wall 151 to frictionally engage the inner wall 111 for more stable installation and movement. Also, a trim 141 can be affixed around the inner wall 111 to aesthetically match the texture and color of the threshold cap 150.

While the above description sets forth one embodiment of a vertically adjustable threshold, the cap as described herein may be used with any vertically adjustable threshold that require top access to perform the vertical adjustment.

The threshold cap 150 can further include an upper cover 158 having inner and outer edges. As best shown in FIGS. 3, 4A, and 4B the outer edge of the cover 158 can be hingedly connected with a flexible hinge 159 to the upper edge of the outer leg 152. The inner edge of the cover 158 can thus form a free end. Proximate the free end, and projecting downwardly from the underside of the cover 158 can be a locking leg 160. Projecting upwardly from the web 153 between the threaded pedestal 154 and the inner leg 151 can be an integrally formed locking wall 163. The inner leg 151 and locking wall 163 can cooperate to create a locking slot 165, also known in the art as a kerf slot. The locking slot 165 is dimensioned such that flexible barbs 161 formed along the locking leg 160 can engage the inside walls of the locking slot 165 when the free end of the cover 158 is pivoted downwardly about the integrally formed hinged connection 159. More particularly, the flexible barbs 161 can be dimensioned to provide hold-down friction and to provide a watertight connection between the inner 151 and outer 152 legs of the threshold cap. As those skilled in the art will appreciate, the locking leg/locking slot sealing arrangement is merely exemplary of locking and sealing mechanisms that may be used for securing the hinged cover 158 closed. For example, the cover 158 could be configured to snap-fit over a lip on the inner leg 151.

While the upper cover 158 is shown in an embodiment formed integral via hinge 159 with the lower portion of the threshold cap, this invention can also include embodiments where the upper cover 158 may be connected to, but not integrally formed with, the lower portion. The connection may be formed by several means known in the art, e.g., mechanical joints, friction bonds, spring bias means, etc.

As also shown in FIGS. 4A and 4B, the threshold cap further can include a longitudinally extending overlapping leg 168 that can be integrally formed with the threshold cap. The overlapping leg 168 can project outwardly from the upper edge of the outer leg 152, curving outwardly and downwardly over the rear vertical wall 136 to the top of the deck 131. To further ensure a positive seal against water, a flexible sealing flange 169 can be hingedly connected to the lower edge of the overlapping leg. The flexible sealing flange 169 can project inwardly and downwardly from the lower edge of the overlapping leg, with a spring-like bias against the rear vertical wall 136.

Referring again to FIGS. 2 and 3, when access is necessary to adjust the threshold cap 150, the user can leverage the cover 158 open by engaging a relief 171, or groove, that is formed in the free end of the cover 158. The relief extends longitudinally at least some portion of the length of the cover 158 and is so dimensioned that a user can insert a fingernail, screwdriver tip, or other suitable item into the relief 171 to lift the cover 158. Sufficient upward force will overcome the frictional hold-down of the barbs 161 on the locking leg 160. As shown in FIG. 3, the cover 158 may then be pivoted upwardly so that the user can easily access the threaded pedestals to adjust the vertical height of the threshold cap 150, as desired, for a sufficient seal. Once the adjustment is complete, the cover 158 can again be pivoted to a closed, locked, and sealed position. Once locked and sealed, the cover 158 again presents a smooth, continuous, and aesthetically pleasing surface along its length. Further, to provide additional downward load bearing support for the closed cover 158 proximate the flexible hinge 159, an optional flange 167 can project inwardly from the outer wall 152 adjacent the underside of the cover 158. This flange 167 can complement the load bearing support provided by the locking leg 160 and locking slot 165.

While various preferred embodiments and features are described above, those of skill in the art will understand that various modifications, variations, changes and additions can be made thereto without departing from the spirit and scope of the invention.

We claim:

1. A vertically adjustable threshold cap capable of installation in a door sill assembly, comprising:
(a) a lower portion that facilitates vertical adjustment, having pedestals that can be manipulated to achieve vertical adjustment; and
(b) a cover connected to the lower portion, and having an access position whereby a user can access and adjust the pedestals, and a closed position whereby no access is provided, wherein the cover remains connected to the lower portion in both positions.

2. The vertically adjustable threshold cap of claim 1 wherein the lower portion comprises:
(a) spaced apart downwardly extending inner and outer legs, the legs having upper and lower edges;
(b) a web extending therebetween the inner and outer legs at a distance between the upper and lower edges of the inner and outer legs;
(c) wherein the pedestals extend through the web for varying the height of the threshold cap;
(d) wherein the cover has an inner edge and an outer edge, one of the inner and outer edges being connected to one of the spaced apart upper edges of the inner and outer legs, and the other of the inner and outer edge being a free end; and
(e) a mechanism for locking the free end of the cover in a closed position when the free end of the cover is pivoted downwardly.

3. The vertically adjustable threshold cap of claim 2 wherein the mechanism for sealing and locking the free end of the cover in a closed position, comprises:
(a) a locking leg extending downwardly from the free end of the cover; and
(b) a locking slot between the inner leg and a locking wall extending vertically upward from the web, wherein the free end of the cover is configured to pivot downwardly about the hinged connection wherein the locking leg engages the locking slot.

4. The vertically adjustable threshold cap of claim 2 wherein in its closed position the cover comprises a substantially smooth and substantially continuous surface beneath a closed door panel.

5. The vertically adjustable threshold cap of claim 2 wherein the locking leg comprises flexible barbs dimensioned to provide hold-down friction and a substantially watertight seal between the inner and outer legs.

6. The vertically adjustable threshold cap of claim 2 further comprising a relief formed in the outer edge of the free end of the cover for access in disengaging the sealing and locking mechanism.

7. The vertically adjustable threshold cap of claim 2 wherein the outer leg further includes an inwardly projecting flange positioned below the hinged connection between the cover and the upper edge of the outer leg, the inwardly projecting flange positioned to provide support to the inner surface of the cover when the cover is in the closed position.

8. A vertically adjustable threshold cap capable of installation in a door sill assembly underneath a door, comprising:
(a) a lower portion and a cover;
(b) the cover further being connected to the lower portion and movable between an access position whereby at least a portion of the lower portion or cover may be vertically adjusted, and a closed position whereby no vertical adjustment can occur;
(c) wherein the cover remains connected to the lower portion when the cover is in both the access position and closed position; and
(d) wherein the cover has a substantially smooth upper surface when the cover is in the closed position.

9. The vertically adjustable threshold cap of claim 8 wherein the cover is formed integral with at least a portion of the lower portion and includes at least one hinge element that facilitates movement from the access position to the closed position.

10. The vertically adjustable threshold cap of claim 9 wherein the cover further comprises a locking leg extending downwardly from the cover.

11. The vertically adjustable threshold cap of claim 10 wherein the lower portion further comprises a receiving portion that receives the locking leg, and assist in maintaining the cover in its closed position.

12. The vertically adjustable threshold cap of claim 10 wherein the locking leg comprises flexible barbs dimensioned to engage the receiving portion.

13. The vertically adjustable threshold cap of claim 9 further comprising a relief formed in an outer edge of the cover to facilitate moving the cover between the closed position and access position.

14. The vertically adjustable threshold cap of claim 9 wherein the lower portion further includes a flange positioned below the hinge element to provide support when the cover is in the closed position.

15. A door sill assembly for installation beneath an entryway having a hinged door panel, the door sill assembly comprising:
(a) an elongated base having an upwardly open channel along an inside edge portion, the channel having an inside wall, an outside wall, and a bottom;
(b) a threshold cap disposed in said upwardly open channel for underlying a closed door, and being vertically adjustable within the channel, the threshold cap comprising:
(i) a lower portion having at least one pedestal; and
(ii) a cover connected to the lower portion, the cover being movable between an access position wherein the at least one pedestal is accessible for vertical adjustment, and a closed position whereby no access is provided; and
(iii) where the cover remains connected to the lower portion in both the access position and closed position.

16. The door sill assembly of claim 15 wherein the lower portion comprises:
(a) spaced apart downwardly extending inner and outer legs, the legs having upper and lower edges;
(b) a web extending therebetween the inner and outer legs at a distance between the upper and lower edges of the inner and outer legs;
(c) wherein the pedestals extend through the web for varying the height of the threshold cap;
(d) wherein the cover has an inner edge and an outer edge, one of the inner and outer edges being connected to one of the spaced apart upper edges of the inner and outer legs, and the other of the inner and outer edge being a free end; and
(e) a mechanism for locking the free end of the cover in a closed position when the free end of the cover is pivoted downwardly.

17. The door sill assembly of claim 16 wherein the mechanism for sealing and locking the free end of the cover in a closed position, comprises:
(a) a locking leg extending downwardly from the free end of the cover; and
(b) a locking slot between the inner leg and a locking wall extending vertically upward from the web, wherein the free end of the cover is configured to pivot downwardly about the hinged connection wherein the locking leg engages the locking slot.

18. The door sill assembly of claim 16 wherein in its locked position the cover comprises a substantially smooth continuous surface beneath a closed door panel.

19. The door sill assembly of claim 17 wherein the locking leg comprises flexible barbs dimensioned to provide engagement between the inner leg and locking slot of the lower portion.

20. The door sill assembly of claim 16 further comprising a relief formed in the outer edge of the cover or lower portion to facilitate alternating between access and closed position.

21. The door sill assembly of claim 16 wherein the outer leg further includes an inwardly projecting flange positioned below the hinged connection between the cover and the upper edge of the outer leg, the inwardly projecting flange positioned to provide support to the inner surface of the cover when the cover is in the closed position.

22. A vertically adjustable threshold cap capable of installation in a door sill assembly having a door, comprising:
(a) a lower portion having threaded pedestals that facilitate vertical adjustment;
(b) a cover connected to the lower portion, the cover having a substantially smooth top surface; and
(c) a means for accessing the threaded pedestals to achieve vertical adjustment, and means for maintaining the cover closed whereby no access is provided, the cover remaining connected to the lower portion during access and closure.
